(19) United States
(12) Patent Application Publication
(10) Pub. No.: US 2005/0051103 A1
(43) Pub. Date: Mar. 10, 2005

(54) Composition with multiple uses for poultry

(76) Inventors: Francis Chi, Kowloon (HK); Qin Tang Wen, Kowloon (HK); Tian Shui Lu, Kowloon (HK)

Correspondence Address: COLEMAN SUDOL SAPONE, P.C., 714 COLORADO AVENUE, BRIDGE PORT, CT, 06605-1601, US

(21) Appl. No.: 10/486,862

(22) PCT Filed: Jul. 12, 2002
(86) PCT No.: PCT/EP02/06430

(30) Foreign Application Priority Data
Jul. 23, 2001 (GB) 01179027

(51) Int. Cl. A01K 45/00

(52) U.S. Cl. 119/6.8

(57) ABSTRACT

The present invention relates generally to the use of cysteamine or a cysteamine-containing composition for (I) increasing the yield and/or quality of eggs produced by fowls, (ii) preferentially promoting growth rate of female fowls over male fowls and/or (iii) preferentially promoting development of breast muscles of fowls over development of muscles other than the breast muscles. The invention also relates to a method and cysteamine-containing feed of raising fowls, and a method of preparing such feed.

### FIELD OF INVENTION

The present invention relates to the use of cysteamine and/or a cysteamine-containing composition for raising poultry or fowls such as hens. The present invention also relates to a method of administering cysteamine and/or the composition to the fowls.

### BACKGROUND OF INVENTION

Cysteamine has been used as an additive in feed in promoting general growth of animals. U.S. Pat. No. 4,711,897 discloses animal feed methods and feed compositions comprising cysteamine. However, it has been identified that cysteamine is a fairly sensitive and unstable compound under normal room temperature conditions. For example, cysteamine is readily oxidized when exposed to air or at an elevated temperature. Cysteamine is highly hydroscopic. Also, cysteamine is unpalatable when taken directly by mouth. Further, ingesting cysteamine directly, will cause undesirable gastro side effects. For these reasons, the use of cysteamine had for a long time been limited to direct injection of cysteamine-containing solution into the animals. The drawback with direct injection is that it is necessarily more costly and difficult to administer in a large farm. The use of cysteamine in its unmodified form in practice has not been possible or at least its effectiveness is hindered in a large scale application,

In a chicken farm, for instance, there are usually several types of chickens raised for specific purposes. For example, in the case of hens, their use is mainly to produce as many quality eggs ns possible. For chickens that are raised to produce meat products, the objective is that they will grow and mature faster so that their meat can be harvested and as such the productivity of the farm can be increased. There is also a type of chickens known an breed chickens used mainly for breeding purpose. Unpublished PRC Patent Application No. 00132107.2 and International Application No. PCT/EP01/14628 discuss an improvement of a cysteamine-containing composition which can be mixed with standard animal feed to promote general growth. However, there continues to exist a need for a single multipurpose composition and/or method for increasing not only the general growth of fowls but also enhance the productivity of the farm in most, if not all, of its fowl types. For example, such multi-purpose composition would at least increase the yield and/or quality of eggs produced by hens. The eggs produced may be used for food. Alternatively, the eggs may be used for breed eggs. Preferably, the method can be easily administered and inexpensive to carry out.

In the case of egg-laying fowls, it has been known that production of eggs thereby shows a pattern of periodicity, which means that as the layers grow older, the production of eggs declines. Studies have indicated that this phenomenon is chiefly resulted from the recession of reproductive capability as the layers age.

While there has been some suggestion that cysteamine may be used to promote the general growth of animals, there has been no or insufficient disclosure of the specific aspects of growth and the specific aspects of use of cysteamine.

It is thus an object of the invention such that one or more of the above issues are addressed, or at least to provide a useful alternative to the public.

### SUMMARY OF THE INVENTION

According to a first aspect of the present invention, there is provided the use of cysteamine or a cysteamine-containing composition for increasing the yield and/or quality of eggs produced by fowls. The yield of eggs means the number of eggs produced in a given period of time and is usually referred as “laying rate”, the definition of which is illustrated in the description below. The quality of eggs refers to the general marketable condition of the eggs and is understood by persons skilled in the field. Abnormal or broken eggs are of course of low quality and thus not marketable. Eggs that have relatively thin shell, and thus may break easily, are of low quality.

According to a second aspect of the present invention, there is provided the use of cysteamine or a cysteamine-containing composition for preferentially promoting growth of female fowls over male fowls. The term “growth” referred to in this aspect of the invention means “total body weight gain”, or “average total body weight gain”.

According to a third aspect of the present invention, there is provided the use of cysteamine or a cysteamine-containing composition for preferentially promoting development of breast muscles of fowls over development of muscles other than the breast muscles

The fowls refer to in the present invention includes but not limited to chickens, ducks, geese and turkeys.

As will be shown below, when administered to egg-laying fowls such as hens, cysteamine or the cysteamine-containing composition has activity in increasing the yield and/or quality of eggs produced therefrom. When administered to fowls primarily for producing meat products, cysteamine or the cysteamine-containing composition has activity in preferentially promoting growth of female fowls over male fowls. When administered to fowls also for producing meat products, the cysteamine-containing composition has activity in preferentially promoting development of breast muscles of the fowls over development of muscles other than the breast muscles. This is significant because in a poultry farm where different types of fowls are raised together, the availability of one effective composition for these different uses means that only one feed type mixed with the single composition may be prepared for these different fowl types. This eliminates the inconvenience and cost of preparing different feed types for and/or administering different compositions to different fowl types. This also eliminates the need of separating different fowl types (e.g. male and female fowls) for raising and feeding.

Preferably, the composition comprises substantially 1 to 95 wt % cysteamine having the chemical formula of NH₂—CH₂—CH₂—SH or its salt-like compounds. More preferably, the composition comprises substantially 30 wt % cysteamine.

Advantageously, the composition comprises 1 to 80 wt % of a stabilizer. The stabilizer is selected from a group including cyclodextrin and/or its derivatives. In particular, the composition may comprise substantially 10 wt % of the stabilizer.

The composition further comprises ingredient(s) selected from a group including a bulking agent, a disintegration agent and a coated carrier. Preferably, the carrier is a solid carrier. The carrier is preferably be a coating soluble in intestines of the fowls. Preferably, the carrier exhibits a multi-layer structure in the composition. The carrier is adapted to remain un-dissolved at an acidic environment of about pH 1.5 to 3.5. The carrier serves to protect the composition until reaching the intestines for absorption.

It is to be noted that the use may be particularly for the manufacture of a feed (material) for raising the fowls. Preferably, the feed comprises substantially 50 to 3000 ppm of the composition. Preferably, the feed comprises substantially 15 to 900 ppm of cysteamine. In particular, the feed may comprise substantially 120 ppm of cysteamine.

The feed may comprise other foodstuffs selected from a group including maize, soybean, yeast, fish bone shell meal, salts, amino acids such as methionine and vitamins.

According to a fourth aspect of the present invention, there is provided a method of raising fowls comprising: (i) mixing cysteamine or a cysteamine-containing composition described above with a suitable feed for the fowls, and (ii) feeding the fowls with the feed. The mixing in step (i) may comprise directly mixing the composition with the feed. Alternatively, the mixing may comprise firstly preparing a pre-mix including cysteamine or the cysteamine-containing composition, and subsequently mixing the pre-mix with the feed. The use of the pre-mix as an intermediate mixer may be preferred because the cysteamine-containing composition can more evenly mixed with the feed.

According to a fifth aspect of the present invention, there is provided a feed for increasing ate yield and/or quality of eggs produced by fowls comprising cysteamine or a cysteamine-containing composition.

According to a sixth aspect of the present invention, there is provided a feed for preferentially promoting growth rate of female fowls over male fowls comprising a cysteamine-containing composition.

According to a seventh aspect of the present invention, there is provided a feed for preferentially promoting development of breast muscles of fowls over development of muscles other than the breast muscles comprising a cysteamine-containing composition.

Preferably, the feed comprises substantially 50 to 3000 ppm of the cysteamine-containing composition. The feed may comprise 15 to 900 ppm cysteamine. In particular, the feed may comprise 120 ppm cysteamine. The feed may comprise other foodstuffs selected from a group including maize, soybean, yeast, fish bone shell meal, salts, amino acids such as methionine, and vitamins.

According to an eighth aspect of the present invention, there is provided a method of preparing a feed described above comprising a step of mixing cysteamine or a cysteamine-containing composition with a suitable basal feed material.

### BRIEF DESCRIPTION OF THE DRAWINGS

The invention will now be described, by way of non-limiting examples only, with reference to the accompanying drawings, in which:—

FIG. 1 is a graph showing the laying rate of two groups of egg-laying hens in an experiment,

FIG. 2 is a graph showing the abnormal egg rate and broken egg rate of the two groups of hens in the experiment;

FIG. 3 is a graph showing the feed conversion efficiency of the two groups of hens during the experiment; and

FIG. 4 is a graph showing the breed egg rate of the two groups of hens during the experiment.

### DETAILED DESCRIPTION OF THE INVENTION

The present invention is based on the demonstration that a single cysteamine-containing composition has different uses in the context of raising different types of poultry or fowls in a farm. For instance, when administered to egg-laying fowls such as hens, the cysteamine-containing composition has activity in increasing the yield and quality of eggs produced therefrom. Prior to this finding, there was no suggestion or sufficient indication that cysteamine or its variants or derivatives might have such activity. The present invention also provides a method for raising egg-laying fowls, particularly hens, by administering and particularly feeding a feed (material) mixed with the cysteamine-containing composition in order to increase the yield and quality of egg production. The use of the present invention also prolongs and heightens the egg-laying performance during later stage of fowls. When administered to a group of male and female fowls primarily for producing meat products, the cysteamine-containing composition has activity in preferentially promoting growth of the female fowls over the male fowls. When administered to fowls that are also for producing meat products, the cysteamine-containing composition has activity in preferentially promoting development of breast muscles of the fowls over development of muscles other than the breast muscles. This eliminates the inconvenience and cost of preparing different feed types for and/or administering different compositions to different fowl types. This also eliminates the need for separating different fowl types (e.g. male and female fowls) for raising and feeding.

The invention may be practiced by directly mixing the cysteamine-containing composition with standard basal feed of a suitable type. Alternatively, the invention may be practised by mixing firstly a pre-mix made of the cysteamine-containing composition and other ingredients, and secondly the premix with the standard feed.

The effects of the cysteamine-containing composition as described in PRC Patent Application No. 00132107.2, International Application No. PCT/EP01/14628 and UK Patent Application No. 0117902.7, the content of which is incorporated herein, on poultry are explained as follows. It is believed that cysteamine having a physiological activity acts as a growth stimulator. Natural cysteamine is a part of coenzyme A (also known as CoA-SH or CoA) which is a coenzyme pattern of pantothenic acid. In the course of metabolism, coenzyme A acts as the carrier of dihydrosulfuryl or variants of hydrosulfuryl which is linked with the hydrosulfuryl of coenzyme A. Experiments performed on other animals such as pigs, poultry, cattle, goats, rabbits and fish have shown that cysteamine can deplete the level of somatostain (SS). This increases the plasma level of growth hormone which in turn raises the level of insulin-like growth factor I (IGF-I). In addition, this is accompanied by increases of other metabolic hormones such as insulin, triiodothyronine (T3), trthyroxine (T4) and beta-endorphin (beta-END). The growth hormone is believed to directly stimulate ovarian actions including steroidogenesis and gametogenesis and ovaluation. The avian ovarian, and particularly the shell gland, is a site of action. It is to be noted chat growth hormone receptors are highly expressed in chicken ovary.

With the increase of these various growth promoting factors, the digestive metabolic rate of the animal is correspondingly increased. It is understood that the feed conversion ratio is hence improved. Further, the general protein synthesis rate of the animal is accordingly increased. The cycles of cell division are also believed to be shortened. On the other hand, the activity of adipose synthesis and transport is decreased. These effects together enhance ovulation of the fowls and thus egg production therefrom (and laying rate) is increased. In terms of promoting growth and particularly increasing the muscle weight of the fowls, it has also been round that cysteamine or the cysteamine-containing compound has a greater effect on female fowls than male fowls. It has also been found that cysteamine or the cysteamine-containing compound has greater effect on the development of breast muscles than other muscles in fowls. This im significant because breast muscles are a major meat source in fowls.

The requirements of cysteamine or the cysteamine-containing composition is now described. It is to be noted that cysteamine used is preferably stabilized by a stabilizer such as cyclodextrin so that it is protected from oxidation before being absorbed. If cysteamine is directly mixed with a basal feed, cysteamine tends to oxidize readily before being absorbed by and into the blood stream of the hens. Although the test batch feed material used in the following Experiments 1 and 2 comprised approximately 120 ppm cysteamine, experiments have shown that the content of cysteamine can vary from 15 ppm to 900 ppm for hens. For fowls of different age and size, a different amount of cysteamine or the cysteamine-containing composition is administered generally according to the body weight of the typo of fowl. For example, when used in increasing the production of eggs in ducks which have larger body weight, the feed used requires a higher content of stabilized cysteamine.

The cysteamine-containing composition comprises two main ingredients of 1 to 95 wt % of cysteamine (or its salts, for example, cysteamine hydrochloride, or other pharmaceutically acceptable acid addition salts thereof) and 1 to 80 wt % of a carrier such as an inclusion compound host material. The chemical formula of cysteamine is HSCH₂CH₂NH₂. The term “cysteamine” referred hereinafter means cysteamine and/or its salt like compounds. Cysteamine and its salts axe well known in the chemical literature

The general chemical formula of a cysteamine salt is C₂H₇NS.X, where X may be HCl, H₃PO₄, bitartrate, salicylate, etc. The cysteamine used is preferably of pharmaceutically acceptable standard and the content of carbon, hydrogen, nitrogen and sulfur therein are substantially 31.14 wt %, 9.15 wt %, 18.16 wt % and 41.56 wt % respectively. While the workable content of cysteamine in the cysteamine-containing composition ranges from 1 to 95 wt %, a preferable range of 1 to 75 wt % and a more preferable range of 1 to 40 wt % of cysteamine may be used. Cysteamine is one of the main active ingredients of the cysteamine-containing composition. However, it has been identified that if the content of cysteamine in the cysteamine-containing composition exceeds 95 wt %, mixing the composition with a basal feed would be rather difficult ad the effect of the composition for regulating growth of animals would be hindered.

The inclusion compound host material comprises mainly cyclodextrin and/or its derivatives which are selected from a group including methyl β-cyclodextrin (M-β-CD), hydropropyl β-cyclodextrin (HP-β-CD), hydroethyl β-cyclodextrin (HE-β-CD), poly-cyclodextrin, ethyl β-cyclodextrin (E-β-CD) and branched cyclodextrin. The general chemical formula of cyclodextrin is (C₆C₅H₉)ₙ.(C₆O₅H₀)and the structural formula is as follows. 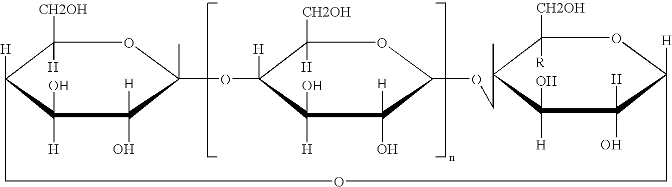
where α-CD n=4; β-CD n=5; γ-CD n=6.
(cyclodextrin is a cyclic oligomer of alpha-D-glucopyranose.)

It is worthwhile to note that the β-CD form of cyclodextrin is preferably used because the internal diameter of its molecule is about 6-8 Å which makes it a particular suitable candidate as an inclusion compound host material for preparation of the cysteamine-containing composition, which involves the use of an inclusion process. The term “cyclodextrin” referred hereinafter means cyclodextrin and/or its derivatives. Any derivative of cyclodextrin which has the property of stabilizing and protecting cysteamine from degradation may be used. For example, any one of the group of cyclodextrin or its derivatives mentioned above may be used.

While the workable content of the inclusion compound host material in the cysteamine-containing composition ranges from 1 to 80 wt %, a preferable work % able range of 1 to 60 wt % and a more preferable workable range of 10 to 40 wt % of the inclusion compound host material may be also be used. The actual amount of the inclusion compound host material used will depend on the actual content of the cysteamine used in preparing the cysteamine-containing composition.

The cysteamine-containing composition also comprises 1 to 90 wt % of fillers although a preferable workable range of 1 to 60 wt % and a more preferable workable range of 1 to 40 wt % or the fillers may also be used in the composition. The actual content will depend on the actual amount of cysteamine and inclusion compound host material used. The fillers is preferably selected from a group including powdered cellulose, starch and calcium sulfate (e.g. CaSO₄.2H₂O). It is to be noted that if the content of the fillers exceeds 90 wt % in the cysteamine-containing composition, the content of the main active ingredients will thus be reduced, and the cysteamine-containing composition may become ineffective in regulating growth of the animals fed with a feed mixed therewith.

The cysteamine-containing composition also comprises 5 to 50 wt % of disintegrants and binders although a preferable workable range of 10 to 40 wt % and a more preferable workable range of 15 to 35 wt % can also be used. The actual content will depend on the actual amount of cysteamine, the inclusion compound host material and other ingredients used. The binders and disintegrants may be selected from a group including hydropropyl starch, microbial alginate, microcrystalline cellulose and starch. It has been identified that if the content of the disintegrants and binders in the composition is less than 5 wt %, granules of the composition produced will lack the required hardness. In addition, manufacturing of the composition would become very difficult. If however the content of the disintegrants and binders is more than 50 wt %, the resulting composition will have excessive hardness, this is especially so if the content of binders represent a large portion of the mixture of the disintegrants and binders. This will result in difficult absorption of the composition by the intestines of the animals.

The cysteamine-containing composition also comprises 0.05 to 0.3 wt % of flavoring and smelling agents which are used as a flavoring essence.

The cysteamine-containing composition also comprises 1 to 20 wt % of a coating material although a preferable workable range is 1 to 15 wt % and a more preferable workable range is 2 to 10 wt %. The actual content will depend on the actual amount of cysteamine, the inclusion compound host material and the other ingredients used. The coating material is preferably enteric-coated which allows dissolution in an alkaline environment such as in the intestines. The coating material may be selected from a group including cellulose acetate phthalate, starch acetate phthalate, methyl cellulose phthalate, glucose or fructose derivatives from phthalic acid, acrylic and methacrylic copolymers, polymethyl vinyl ether, partly esterified substance of maleic anhydride copolymers, takh and formogelatine. It has been identified if the content of the coating material is less than 1 wt %, granules of the composition may not be entirely covered by the coating material which act as a protective layer. The cysteamine-containing composition may thus degrade before being absorbed by the intestines into the bloodstream of the animals. On the other hand, if the content of the coating material exceeds 15 wt %, the active ingredients in the composition may not effectively be released from the composition. Thus, the intended regulation of growth would be not achieved. In any event, it has been identified that an animal feed comprising 250 to 700 mg/kg of the composition is effective, when fed to the animal, in increasing its body weight.

The cysteamine-containing composition is preferably in the form of small granules each of which has a preferable diameter of substantially 0.28 to 0.90 mm. These granules are prepared using a micro-encapsulation method. The method involves using a macromolecular substance having inclusion properties. One substance which may be used is the inclusion compound host material (which comprise mainly cyclodextrin) described above. The inclusion compound host material is a macromolecular substance which acts as a molecular capsule to engulf the molecules of cysteamine, whereby cysteamine in the composition is protected and insulated from light, heat, air and moisture of the surroundings. The stability of cysteamine is thus preserved. The inclusion compound host material used in the micro-encapsulation method is preferably a cyclic polysaccharide compound having 6 to 12 glucose molecules, which is produced by reacting cyclodextrin glycosidtransferase and starch in the presence of Bacillus. Various studies using acute, subacute and chronic toxic tests have shown that the macromolecular substance is non-toxic. Subsequent to the micro-encapsulation process, each granule may be coated with at least one and preferably a plurality of layers of the coating material described above. The following provides a more detailed description of one embodiment of a method of preparing the cysteamine-containing composition according co the present invention.

In a jacketed reactor linked with polytetrafluoroethylene and equipped with a polytetrafluoroethylene coated stirrer, 4080 g of 75 wt % cysteamine hydrochloride solution in ethanol is added with mainly nitrogen being the atmosphere. The purity, melting point and burning residue of the cysteamine used are preferably 98% or above, 66 to 70° C. and 0.05% or below respectively. 1200 g β-cyclodextrin is then added into the reactor similarly under the protection of nitrogen gas. (The quality of β-cyclodextrin is in accordance with the requirements for a food additive. In particular, the dry basis purity is more than 98%; the weight lose by drying is less than 10.0%; the burning residue is less than 0.2%; the content of heavy metal is less than 10 ppm; the arsenic content is less than 2 ppm.) The mixture is then heated for 3 hours at 40° C. Heating is then stopped and stirring continues for two hours thereafter, products resulted therefrom are then grounded and sieved through a screen (e.g. 40-mesh) filter after the products have been vacuum dried at a temperature of 40-50° C. All parts of the equipment, which may come in contact with the ingredients of the composition, should preferably be made of stainless steel.

In a tank-type mixer, 4200 g (on dry basis) of the cysteamine which has undergone the inclusion process as described, 2600 g of the fillers, and 1200 g of the disintegrants and 1700 g binders are added under the protection or a dry surroundings. These ingredients are then thoroughly mixed, and a suitable amount of anhydrous ethanol may be added and then mixed therewith. The resulting mixture presents a soft material with moderate hardness, so that it can be shaped into a ball by a light hold of palms. The ball-shaped resulting mixture may then be broken up by a light touch. After the mixture is pelleted by a granulator under the protection of nitrogen, the small granules resulting therefrom is immediately introduced to a fluid-bed dryer, and is then dried at the temperature of 40-50° C. in a substantially vacuum environment.

Enteric coating material is then prepared by a method with the following formulation: cellulose acetate phthalate 8.0 g, polyethylene glycol terephthalate 2.4 ml, ethyl acetate 33.0 ml and isopropyl acetate 33.6 ml. The resultant granules obtained above are uniformly coated under the protection of nitrogen with at least one layer but preferably a plurality of layers the enteric coating material described above. The enteric coating material is dissolvable only at an alkaline environment. This can prevent the cysteamine from prematurely escaping from the composition while it is still in the stomach of the animal. Cysteamine can adversely stimulate gastric mucous of the stomach of the animals.

The resultant granules of the cysteamine-containing composition are then dried completely in a substantially vacuum dryer at a temperature of 40 to 50° C. Then, all solvents are removed. The resultant granules are then allowed to cool to room temperature, the micro-capsules are mixed with a suitable amount of flavoring and smelling agents by a cantilever double helix blender. The cystreamine-containing composition in a microcapsule with its interior having cysteamine hydrochloride and cyclodextrin, and with its exterior coated with the enteric coating material.

The composition produced will exhibit small granular (or micro-particulate) shape having smooth surface, good flow property, and is easy to be blended with various animal feeds. The diameter of each granule of the composition is preferably 0.28 to 0.90 mm. The composition also has excellent stability. It has been found that after the composition is packaged with sealed plastic bags and stored for one year in a cool, dark and dry place, their properties remain unchanged. Therefore, they meet the requirements for a feed additive.

The composition having the particular construction described above has a number of functional advantages over cysteamine by itself. Firstly, the activity of the cysteamine contained in the composition is preserved after it has been produced. This is important as feed additives such as the composition may be stored for a relatively long period of time before use. Secondly, the composition does not cause any noticeable gastro side effects to the animals fed therewith. Thirdly, the activity of the composition is preserved not only during storage but more importantly until it reaches the intestines of the animals. Fourthly, the composition can be easily administered to farm animals on a large scale basis cost-effectively because it can be readily mixed with any basal feed. No separate procedure or injection is needed at all.

Various experiments have been conducted to demonstrate that administering cysteamine or the cysteamine-containing composition (e.g. via a diet) achieves the effects in poultry as explained above, some experiments of which are described in detail as follows.

### EXPERIMENTS

### Experiment 1

Background Information

The experiment was conducted in an industrial chicken-breeding farm located in the Shengbao, Shanghai, PRC in February and March 2001. Chickens of the Hailan breed with an age of 305 days were used. During the experiment, the subject chickens were kept in cages arranged in a standard semi-opened chicken farmhouse equipped with automatic feeding and drinking systems. The subject chickens included a total of 2042 egg-laying hens, 1200 of which were used for control purposes and the rest were used for test (experimental) purposes. The basal diet used to feed the hens included mainly maize and soybean. The details of the basal diet are described further below

Materials

Two batches of feed were prepared, the test batch comprising a cysteamine-containing composition and the control batch comprising the basal diet containing no such composition. The cysteamine-containing composition being in mini-pill form comprised about 30 wt % cysteamine together with other ingredients including cyclodextrin which serves as a stabilizer. The content of cyclodextrin in the composition was 30 wt %. The composition was prepared by Walcom Bio-Chemicals Industry Limited. For the test batch of feed, the composition was firstly mixed with various pre-mixing ingredients including amino acids, salts, phosphorous, calcium, and crude proteins to form a pre-mix. The premix was subsequently mixed with a suitable basal feed as explained. The approximate formula of the basal feed is summarized in Table 1 below. The concentration of the composition in the basal feed was substantially 400 ppm. In other words, the effective concentration of cysteamine in the feed material was about 120 ppm.

TABLE 1

| | Composition, | |
|---|---|---|
| Ingredients | wt % of total | Nutrient Composition |
| Maize | 66.6 | 11.23 MJ/kg. metabolizable energy (ME) |
| Soybean | 16.3 | 16.76 wt % crude protein (CP) |
| meal | | |
| Yeast | 3.7 | 0.39 wt % methionin (MET) |
| Fish meal | 2.0 | 0.69 wt % methionin |
| | | (MET) & cystine (CYS) |
| Bone meal | 3.0 | 0.79 wt %, lysine |
| Shell meal | 7.5 | 3.71 wt %, calcium |
| Pre-mix | 1.0 | 0.55 wt %, total phosphorous (TP) |
| Salts | 0.30 | 0.45 wt %, available phosphorous [AP] |
| Methionine | 0.18 | — |
| Total | ˜100 | — |

In practice, the cysteamine-containing composition may actually contain 1 to 95 wt % cysteamine. However, it is preferred that the feed is in any event adjusted to contain approximately 50 to 3000 ppm of the composition. Alternatively, the test batch material may have an effective content of about 15 to 900 ppm cysteamine in practice. As noted above, the composition used in the experiment comprised about 10 wt % cyclodextrin. However, depending on the actual amount of cysteamine used in preparing the composition, the composition may contain 1 to 80 wt % of the stabilizer (e.g. cyclodextrin), as well as other ingredients which may include a bulking agent, a disintegration agent and a solid coated carrier. The composition is preferably in the form of mini-pill having a multi-layer structure. The composition thus remains relatively stable at room temperature conditions and un-dissolved at a pH as low as 1.5 to 35 (such as in a stomach environment) after it has been ingested by the animal. The carrier is preferably made of a coating material which is soluble normally only in a higher pH environment such as in the intestines.

When preparing the control batch of feed, the pre-mix used did not contain the cysteamine-containing composition.

Procedure

2042 hens were initially used in the experiment. These hens were randomly divided into a control group of 1200 hens and test (experimental) group of 842 hens. All 2042 hens were initially kept under the same conditions except the control group was feeding on the control batch of feed without the cysteamine-containing composition and the test group was feeding on the feed comprising the cysteamine-containing composition. During the initial four-day and subsequent 25-day period, the yield and quality of egg production were recorded. The quantities of feed used for both groups were also recorded. The laying rate is calculated by the following formula.

$$laying rate = \frac{total number of eggs produced}{number of layer ( hens )} \times 100 \%$$

In addition, data for calculating the breed egg rate, the fertility and hatchability rates of the eggs, the breed chicken rate and the feed conversion efficiency produced by the two groups of hens were also recorded.

The number of breed (breedable) eggs is calculated according to the following formula.
total number of breed eggs=total number of eggs produced−total abnormal and broken eggs

Abnormal eggs include those eggs which lack the typical oval egg shape and thus render them unmarketable.

The breed egg rate is the number of breed eggs produced by the hens as a percentage of the total number of eggs produced, which can be expressed by the following formula.

$$breed egg rate = \frac{\begin{matrix}total number of eggs produced - \\ [ total number of abnormal and broken eggs ]\end{matrix}}{total number of layers ( hens )} \times 100 \%$$

The fertility rate of eggs is the number of fertilized eggs produced by the hens as a percentage of the total number of breed eggs, which is calculated by the following formula.

$$fertility rate = \frac{total number of fertile eggs}{total number breed eggs} \times 100 \%$$

The hatchability rate of eggs is the percentage of breed eggs finally hatched. The breed chicken rate is the percentage of breed eggs hatched into healthy chickens suitable for further commercial exploitation.

After the initial four-day period, the test group of hens continued to be fed with the test batch of feed containing the cysteamine-containing composition while the control group remained being fed with the control batch of feed for 25 days. The yield and quality of egg production as well as the quantity of feeds used were likewise monitored and recorded. Data for calculating the breed egg rate, the fertility and hatchability rates of the eggs produced by the two groups of hens, the breed chicken rate and the feed conversion rate (FCR or feed conversion efficiency) were similarly recorded. The FCR is calculated using the following formula.

$$FCR = \frac{total weight of feed material consumed per day}{total weight of eggs laid per day}$$

At the age of 325 days, 30 hens were randomly selected from each of the two groups of hens. During a five-day period therefrom, their feces were collected and analyzed for the content of water and the main nutrients including organic matter, crude proteins, crude ash, calcium and phosphorus. The organic matter includes the crude protein. The crude ash includes all inorganic contents such as calcium and phosphorous. The percentages of metabolized nutrients (i.e. feed metabolic rate) were then calculated.

The experiment lasted for 29 days in total including the initial 4-day pre-experiment period.

Results and Discussions

Raw data collected was used to generate Table 2 below which shows the laying rate, the abnormal egg rate, the broken egg rate and the feed conversion rate (FCR) of the two groups of hens.

TABLE 2

| Outcome | | | | | | |
|---|---|---|---|---|---|---|
| (%)♯period | Pre-experiment | Pre-experiment | Comparison | Experiment | Experiment | Comparison |
| Group | Control | Test | | Control | Test | |
| Day | 1 to 4 | 1 to 4 | | 5 to 29 | 5 to 29 | |
| No. of days | 4 | 4 | | 25 | 25 | |
| Laying rate | 82.28 ± 5.14 | 80.20 ± 0.93 | P > 0.05 | 78.99 ± 2.26 | 82.04 ± 2.65 | P < 0.01 |
| Breed egg | 79.08 ± 4.81 | 78.69 ± 0.75 | P > 0.05 | 75.72 ± 2.65 | 79.99 ± 2.66 | P < 0.01 |
| rate | | | | | | |
| Abnormal | 2.39 ± 1.10 | 1.44 ± 0.24 | P > 0.05 | 2.80 ± 0.98 | 1.83 ± 0.36 | P < 0.01 |
| egg rate | | | | | | |
| Broken egg | 1.47 ± 0.05 | 0.45 ± 0.12 | P < 0.05 | 1.33 ± 0.27 | 0.68 ± 0.16 | P < 0.01 |
| rate | | | | | | |
| Feed | 2.70 ± 0.26 | 2.54 ± 0.03 | P > 0.05 | 2.78 ± 0.16 | 2.51 ± 0.08 | P < 0.01 |
| conversion | | | | | | |
| rate | | | | | | |

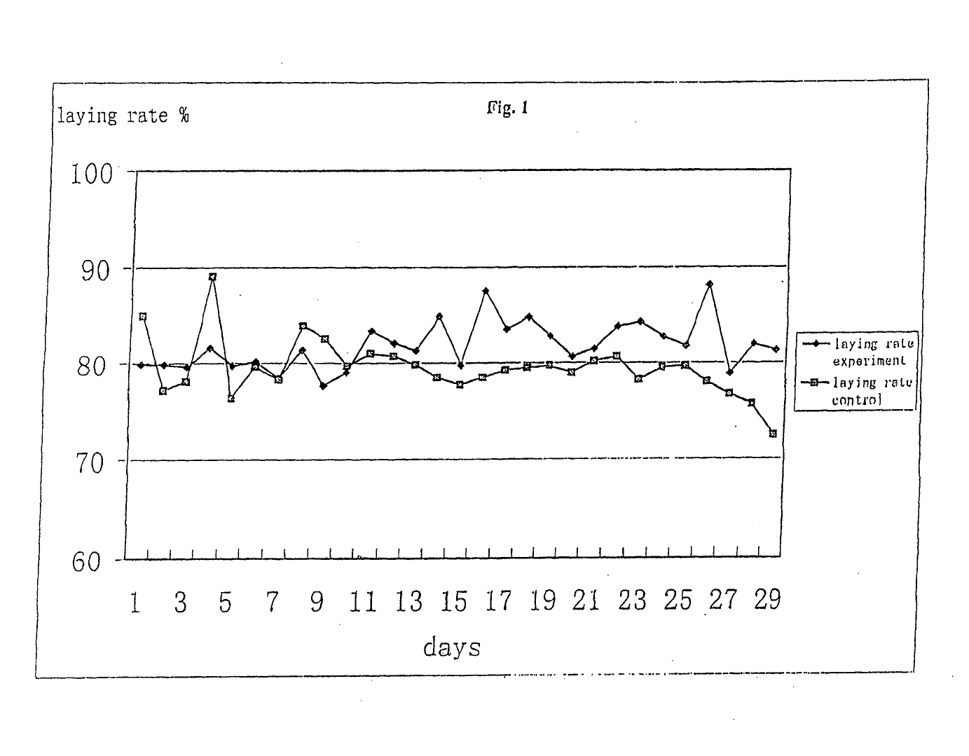

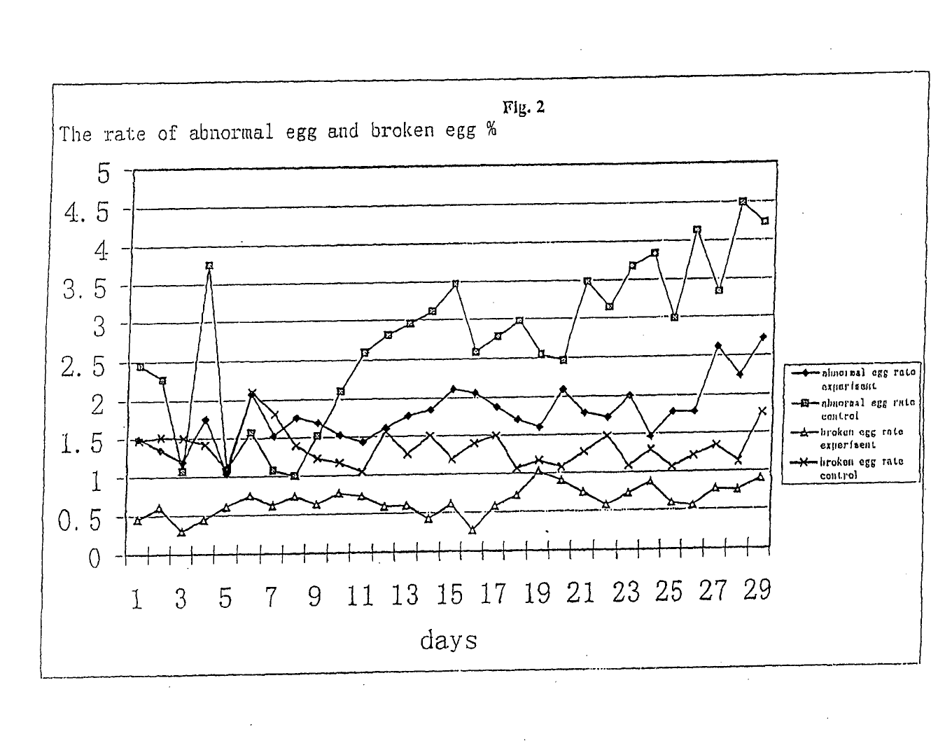

FIG. 1 illustrates the laying rate in a graphical format. FIG. 2 illustrates the abnormal egg rate and the broken egg rate in a graphical format. As shown in Table 2 and FIG. 1, the egg-laying rate of the test group during the 25-day experimental period was generally higher than the corresponding control group by 3.86%. Referring to Table 2 and FIG. 2, there were generally substantially less abnormal and broken eggs produced by the test group of hens during the experiment period. The number of breed eggs was increased by 5.64%. Using the data of feed conversion efficiency in Table 2, it is calculated that the test group of hens has a 9.71% higher feed conversion rate. This means that the test group of hens fed with the test batch of feed can more efficiently convert feed into egg production.

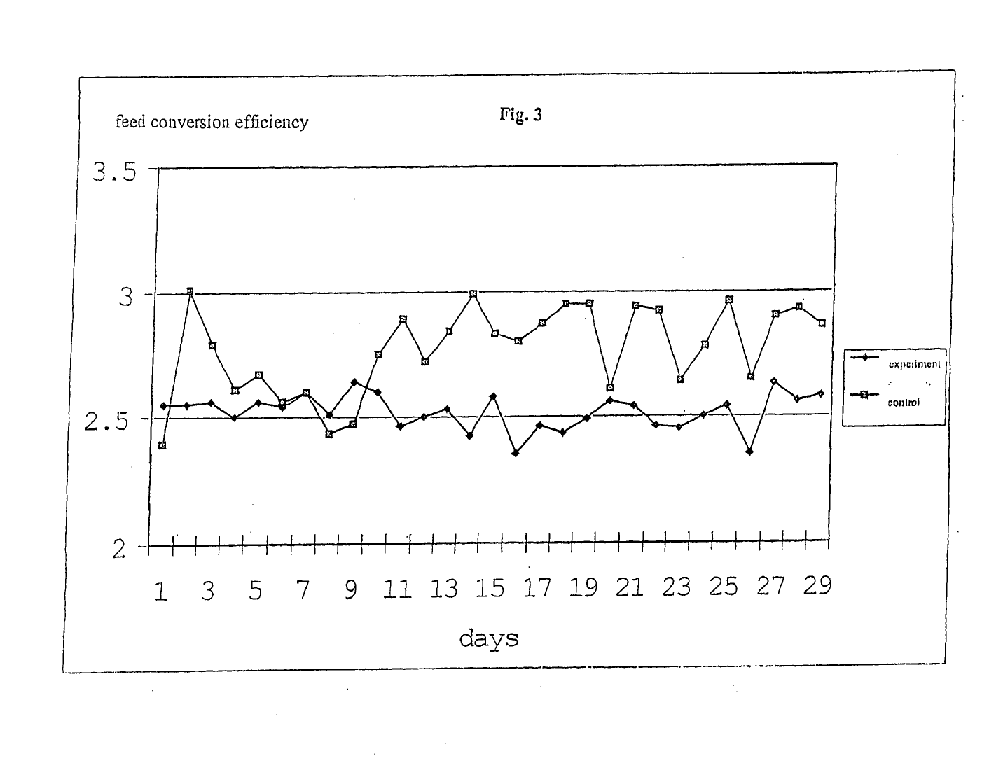

FIG. 3 shows the variation of the feed conversion rate during the experiment. The general lower feed conversion efficiency of the test group of hens illustrates that the group could more efficiently convert feed into egg production.

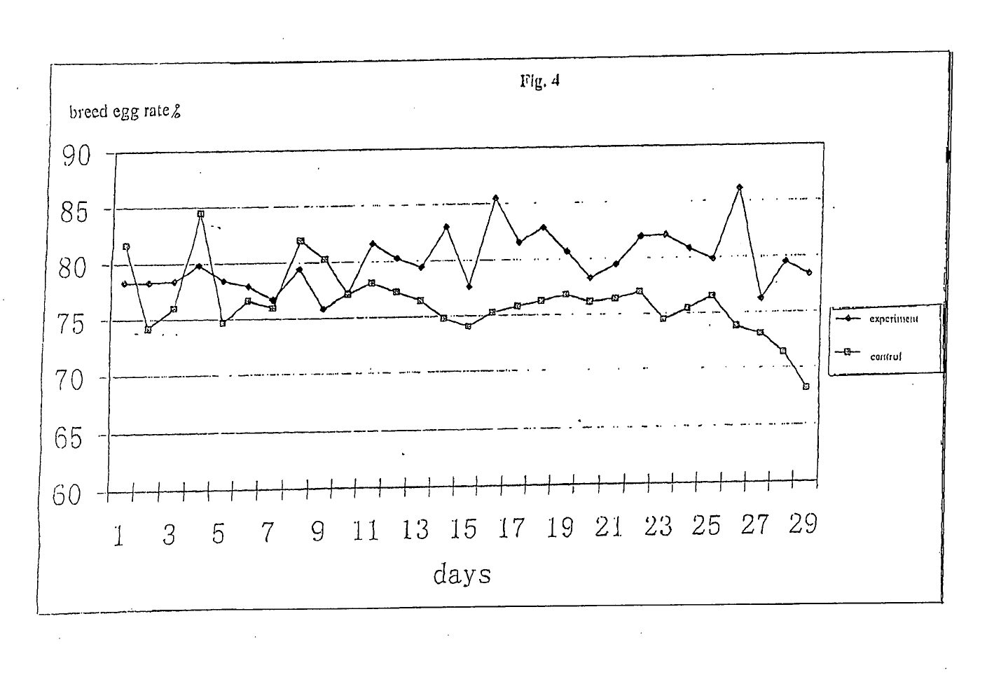

FIG. 4 shows the variation of the breed egg rate of the two groups of hens during the experiment. The curve represented by the test group of hens is generally above that of the control group. This means that the test group of chicken was able to produce a higher percentage of good quality eggs. It is to be noted that in the figure, the experimental curve generally fluctuates and maintains in the region of about 80% throughout the experiment while the control curve declines towards the end of the experiment. This indicates that as the hens in the control group aged, their egg production decreased, on the other hand, the test group of hens fed with feed having cysteamine-containing composition was able to maintain a relatively high production of breed eggs throughout the experiment.

Table 3 below summarizes the percentage of metabolized nutrients.

TABLE 3

| | Organic | Crude | Crude | Calcium | Phosphorous |
|---|---|---|---|---|---|
| Group | matter (%) | protein (%) | ash (%) | (%) | (%) |
| Control | 88.86 | 81.05 | 83.60 | 84.95 | 73.42 |
| Test | 88.48 | 80.82 | 85.82 | 87.30 | 79.64 |

As can be seen in Table 3, there is no significant difference of the metabolic rate on the organic matter and crude protein between the two groups of hens. However, there is a higher percentage of metabolized calcium and phosphorous in the test group of hens. This indicates that the selected hens from the test group were able to retain and absorb a higher percentage of calcium and phosphorous in their diet. It is believed that there is a more efficient conversion of calcium and phosphorous to the eggshell which contributes to the higher quality of eggs (i.e. less broken and abnormal eggs) produced therefrom.

Table 4 below shows that the eggs produced by both the test and control groups of hens have similar fertility rates, hatchability rates and breed chicken rates.

TABLE 4

| | | | | | Breed |
|---|---|---|---|---|---|
| | | Breed | Fertility | Hatchability | chicken |
| From | Group | eggs | rate (%) | rate (%) | rate (%) |
| 28 FEB to 21 MAR | Control | 750 | 89.6 | 77.1 | 38.3 |
| 28 FEB to 21 MAR | Test | 900 | 89.4 | 78.4 | 38.0 |
| 8 MAR to 29 MAR | Control | 600 | 89.6 | 77.8 | 38.2 |
| 8 MAR to 29 MAR | Test | 900 | 89.5 | 78.1 | 38.3 |
| 14 MAR to 4 APR | Control | 750 | 89.7 | 76.9 | 38.5 |
| 14 MAR to 4 APR | Test | 750 | 89.5 | 77.3 | 38.4 |

| | | | |
|---|---|---|---|
| Control | 89.6 | 77.3 | 38.3 |
| Test | 89.5 | 77.9 | 38.2 |

It is thus demonstrated that the use of a feed mixed with cysteamine or a cysteamine-containing composition increases the egg-laying rate and breed egg rate of hens. It is also shown that less abnormal eggs and broken eggs are produced by hens administered with such a feed. In other words, the quality of eggs is improved. Further, the fertility, hatchability and breed chicken rate of the eggs are not affected by the administration of cysteamine or the cysteamine-containing composition.

### Experiment 2

Background Information

The experiment was conducted in an industrial chicken farm located in Nanjing, PRC during a sixty-three day period from 18 Oct. 2001 to 25 Dec. 2001. 1000 healthy egg-laying hens with an age of 445 days were purchased from a farm. The hens before purchase had no abnormality in their egg production. The hens were randomly divided equally into a test and control group. The hens in the test and control groups were further divided into sub-groups of 100. The hens were raised in semi-open farmhouses with cages arranged in a staggered manner. The farmhouses were illuminated with natural sunlight supplemented by artificial light for at least sixteen hours a day.

Materials

Each group of hens was fed once at 7 am with 60 kg of feed (i.e. about 120 g per hen) and then again later in the day with 12 kg of a basal feed. The basal feed included 61.5 wt % of maize, 23 wt % of bean, 2 wt % of oatmeal, 8.5 wt % of shell meal 5 wt % of a pre-mix material. The nutritional value of the feed is approximately 11.55 MJ/kg with about 16.5 wt % proteins, 0.4 wt % of phosphorous and 3.63 wt % of calcium. Both the test and control groups of hens were fed with the same basal feed except that in the basal feed for the test groups of hens, the 5 wt % pre-mix were added with 400 mg/kg of a cysteamine-containing composition which was also used in the above Experiment 1. The method of making the cysteamine-containing composition is described in greater detail later in the description.

Procedure

Eggs laid by the hens were collected at 2 pm each day. The room temperature of the farmhouses was monitored and recorded at 8 am and 3 pm. The general conditions of the hens and the eggs produced therefrom were recorded at 3 pm in each day of the experiment. The experiment was preceded with a week of standardization period followed by a nine-week experiment period. During the fifth and ninth weeks, six eggs were randomly selected from the eggs produced by each group of hens. The condition of each of these six eggs including the thickness of the egg shell at various location of the eggs was measured and recorded.

Results and Discussions

Raw data from the experiment was then inputted in a computer for processing using the computer software called Statistica™.

Table 5 below summarizes the number of eggs produced by the control and test group of hens.

TABLE 5
Laying rate, %, X ± SD

| Week\Group | Control | Test |
|---|---|---|
| Week 1 | 65.64 ± 1.01 | 69.22 ± 1.92** |
| Week 2 | 68.81 ± 2.14 | 72.67 ± 1.71** |
| Week 3 | 68.35 ± 1.54 | 72.05 ± 1.46** |
| Week 4 | 67.02 ± 2.48 | 72.73 ± 1.85** |
| Week 5 | 62.13 ± 2.35 | 69.36 ± 1.46** |
| Week 6 | 61.23 ± 1.38 | 70.73 ± 1.29** |
| Week 7 | 61.55 ± 1.83 | 72.13 ± 1.65** |
| Week 8 | 59.31 ± 1.66 | 69.66 ± 3.42** |
| Week 9 | 54.90 ± 2.65 | 63.96 ± 3.07** |
| Average | 63.37 ± 4.67 | 70.38 ± 3.17** |

**P < 0.01

As shown in Table 5, the test group of hens produced consistently more eggs throughout the experiment. In particular, the test group of hens administered with a cysteamine-containing diet produced about 11.06% more eggs than the control group of hens on average. This is a very significant increase by the industry's standard.

Table 6 below summarizes the weight of the eggs produced and the feed conversion efficiency of the two groups of hens.

TABLE 6
Weight of eggs, feed conversion rate

| | Control | Control | | Test |
|---|---|---|---|---|
| | Weight | Feed | Test | Feed |
| | of | Conver- | Weight | Con- |
| Week\ | eggs | sion | of eggs | version |
| Group | (kg) | Rate | (kg) | Rate |
| Week 1 | 21.00 ± 0.70 | 2.86 ± 0.10 | 22.36 ± 0.53 | 2.69 ± 0.60 |
| Week 2 | 22.33 ± 0.64 | 2.69 ± 0.08 | 23.54 ± 0.61 | 2.55 ± 0.07 |
| Week 3 | 21.09 ± 0.50 | 2.74 ± 0.07 | 23.76 ± 0.55 | 2.53 ± 0.06 |
| Week 4 | 21.66 ± 1.39 | 2.78 ± 0.19 | 23.83 ± 0.72 | 2.52 ± 0.07 |
| Week 5 | 19.91 ± 0.84 | 3.02 ± 0.12 | 22.65 ± 0.48 | 2.64 ± 0.08 |
| Week 6 | 20.14 ± 0.59 | 2.98 ± 0.09 | 23.30 ± 0.37 | 2.58 ± 0.04 |
| Week 7 | 20.29 ± 0.62 | 2.96 ± 0.09 | 23.91 ± 0.48 | 2.51 ± 0.05 |
| Week 8 | 19.99 ± 0.48 | 3.01 ± 0.07 | 23.16 ± 1.17 | 2.59 ± 0.13 |
| Week 9 | 18.38 ± 1.07 | 3.27 ± 0.18 | 21.20 ± 1.04 | 2.84 ± 0.14 |
| Average | 20.62 ± 1.23 | 2.92 ± 0.18 | 23.08 ± 0.88** | 2.60 ± |
| | | | | 0.11** |

P < 0.01

As shown in Table 6, the weight of total eggs: produced by the test group of hens was consistently higher than that produced by the control group of hens. In particular, the weight of total eggs was 11.931 higher. The feed conversion rate of the test group of hens was significantly lower than that of the control group of hens. In particular, the feed conversion rate of the test group of hens was 10.96% lower.

Table 7 below summarizes the average weight of the eggs produced by the two groups of hens.

TABLE 7
Average weight of eggs

| | in g | in g |
|---|---|---|
| Week\Group | Control | Test |
| Week 1 | 64.24 ± 1.23 | 64.60 ± 0.29 |
| Week 2 | 65.43 ± 0.65 | 65.02 ± 0.75 |
| Week 3 | 65.57 ± 1.04 | 65.50 ± 1.15 |
| Week 4 | 66.10 ± 2.89 | 66.16 ± 0.39 |
| Week 5 | 66.55 ± 4.51 | 66.31 ± 0.59 |
| Week 6 | 65.85 ± 2.16 | 66.96 ± 0.51 |
| Week 7 | 67.69 ± 2.61 | 67.53 ± 0.42 |
| Week 8 | 69.17 ± 2.03 | 67.74 ± 0.23 |
| Week 9 | 69.06 ± 2.12 | 67.88 ± 0.42 |
| Average | 66.67 ± 2.74 | 66.45 ± 1.24 |

As shown in Table 7, the average weight of eggs produced by the hens in the test group was about the same as that of the hens in the control group of hens (P>0.05).

Table 8 below summarizes the number of eggs with broken shell of the two groups of hens.

TABLE 8
Eggs with broken shells, X ± SD

| | broken egg rate, % | broken egg rate, % |
|---|---|---|
| Week\Group | Control | Test |
| Week 1 | 0.742 ± 0.304 | 0.410 ± 0.421 |
| Week 2 | 1.004 ± 0.277 | 0.353 ± 0.207 |
| Week 3 | 0.882 ± 0.324 | 0.477 ± 0.208 |
| Week 4 | 0.771 ± 0.439 | 0.317 ± 0.299 |
| Week 5 | 0.602 ± 0.392 | 0.461 ± 0.331 |
| Week 6 | 0.942 ± 0.383 | 0.409 ± 0.360 |
| Week 7 | 1.509 ± 0.472 | 0.804 ± 0.241 |
| Week 8 | 1.468 ± 0.540 | 0.713 ± 0.168 |
| Week 9 | 1.127 ± 0.646 | 0.913 ± 0.334 |
| Average | 1.003 ± 0.501 | 0.534 ± 0.34** |

**P < 0.01

As shown in Table 8, the broken egg rate was reduced from 1.003 to 0.534, or by 46.76% (P<0.01). The reduction is statistically very significant

Table 9 below summaries the data of the thickness of eggshell.

TABLE 9
Thickness of eggshell

Thickness of eggshell, mm

| Week\Group | Control | Test |
|---|---|---|
| Week 5 | 0.42 ± 0.04 | 0.45 ± 0.04** |
| Week 9 | 0.44 ± 0.03 | 0.47 ± 0.03** |

**P < 0.01

As shown in Table 9, it is shown that the eggshell of the eggs produced by the test group of hens during the fifth and ninth week was significantly thicker than that of the control group of hens by 7.14% and 6.82% respectively.

Table 10 summaries the death rate of the two groups of hens.

TABLE 10
Death rate of hens

| Stage of Experiment\ | | |
|---|---|---|
| Group | Control | Test |
| Beginning | 500 | 500 |
| End | 491 | 489 |
| Death | 9 | 11 |
| Death rate, % | 1.80 ± 1.30 | 2.20 ± 1.48 |

As shown in Table 10, the test group of hens had a death rate of 2.20% which was higher than that in the control group of hens. The difference is however relatively small and negligible in the context of chicken farming.

The results in Experiments 1 and 2 are generally consistent

### Experiment 3

Background Information

This experiment sought to ascertain the effect(s) of a cysteamine-containing composition on growth in poultry such as chickens. There has been no or insufficient teaching as to the specific aspects of growth that cysteamine may be effective in raising fowls.

In this experiment, 300 broilers of both sexes with an average age of one day were used. Each broiler was tagged with a number on its wing for identification. 240 broilers were randomly selected as the test group broilers and divided evenly into 6 groups. In each group of 40 broilers, they were further randomly divided into sub-groups of 10. All broilers were kept in air-conditioned farmhouses with infrared and light illumination, unrestricted supply of water and feed. The experiment lasted for about 6 weeks. The temperature of the farmhouses were maintained at about 35° C. for the first week and decreased in steps to 21° C. by the end of the fourth week. The temperature was kept at about 20 to 21° C. subsequent to the fourth week of the experiment. The broilers were immunized with vaccines as summarized in Table 11 below,

TABLE 11
Immunization of broilers

| Age (day) | Vaccine type | Immunization route |
|---|---|---|
| 1 | Marek's disease | Injection |
| 8 | Newcattle disease | Nose drop |
| 14 | Infectious bursel | Nose drop |
| | disease | |

Materials

The ingredients and nutritional value of a basal feed used to feed the broilers are summarized below in Table 12 and 13 respectively.

TABLE 12
Ingredients of basal feed

| Ingredient, wt % | Age during day 0 to 21 | Age during day 22 to 42 |
|---|---|---|
| Maize | 57 | 60 |
| Bean | 35 | 30 |
| Fishmeal | 2 | 1.5 |
| Plant oil | 1 | 1.5-3.0 |
| Pre-mix | 5 | 5 |
| Methionine | 0.06 | 0.06 |

TABLE 13
Nutritional value of the basal feed

| Nutritional | Age during | |
|---|---|---|
| composition | day 0 to 21 | Age during day 22 to 42 |
| Crude protein (%) | 21.37 | 19.200 |
| Metabolic energy (Kcal/kg) | 2.850 | 3.002 |
| Fat (%) | 3.650 | 6.130 |
| Sodium chloride (%) | 0.350 | 0.350 |
| Calcium (%) | 0.906 | 0.900 |
| Phosphorous (%) | 0.450 | 0.420 |
| Lysine (%) | 1.109 | 1.000 |
| Methionine (%) | 0.513 | 0.465 |
| Methionine + Cystine (%) | 0.837 | 0.761 |

A trace amount of copper, manganese, iron, zinc, selenium, iodine, and vitamins meeting the nutritional requirements of AA broilers was added to the basal feed.

Procedure

The six groups of broilers were fed with the basal feed but added with different amount of the cysteamine-containing composition during the experiment. The cysteamine-containing composition used was the same composition used in Experiments 1 and 2. The composition and the method of making thereof is described in derail later in the description. Table 14 summarizes the concentration of the cysteamine-containing composition in the basal feed used during the experiment.

TABLE 14
Concentration of cysteamine-containing
composition in basal feed

| Group Name | Age: day 1 to 10 | Age: day 11 to 21 | Age: day 22 to 42 |
|---|---|---|---|
| Control | 0 | 0 | 0 |
| E1 | 200 | 200 | 200 |
| E2 | 0 | 200 | 200 |
| E3 | 0 | 0 | 200 |
| E4 | 0 | 400 | 400 |
| E5 | 0 | 0 | 400 |

At the end of the experiment, the broilers were slaughtered after twelve hours of fasting and the weight of different parts of the broilers was measured. In particular, the following weights were measured.
(a) Total body weight before slaughter;
(b) Total body weight after slaughter and cleaning;
(c) Half thorax weight;
(d) Whole thorax weight;
(e) Thigh muscle weight;
(f) Leg muscle weight; and
(g) Breast muscle weight.
   Results and Discussions

Tables 15 to 17 below summarize the average total body weight of all the broilers and that of the male and female broilers respectively after the experiment.

TABLE 15
Average total body weight of all the broilers

| | | | | Change in | |
|---|---|---|---|---|---|
| Group Name | | Change in | Change in | body weight | |
| (No. of | Body weight | body weight | body weight | compared to | P value (body |
| broilers) | (kg) | (%) | (kg) | control (%) | weight gain) |
| Control (37) | 1.706 ± 0.068 | 0.00 | 1.663 ± 0.068 | 0.00 | n/a |
| E1 (33) | 1.684 ± 0.075 | −1.31 | 1.642 ± 0.075 | −1.27 | 0.83489 |
| E2 (37) | 1.672 ± 0.052 | −1.98 | 1.631 ± 0.052 | −1.92 | 0.708706 |
| E3 (35) | 1.807 ± 0.055 | 5.898 | 1.765 ± 0.055 | 6.15 | 0.24721 |
| E4 (37) | 1.866 ± 0.054 | 9.393 | 1.824 ± 0.054 | 9.68 | 0.067987 |
| E5 (37) | 1.842 ± 0.045 | 7.960 | 1.800 ± 0.045 | 8.24 | 0.096129 |

As can be seen in Table 15, the broilers in Groups E4 and E5 were significantly heavier than those in the other groups. This indicates that when administered with a cysteamine-containing diet at an effective dose at the appropriate developmental stage, the cysteamine-containing diet is effective in promoting the growth with respect to the increase in total body weight.

TABLE 16
Average total body weight of the male broilers

| | | | | Change in | |
|---|---|---|---|---|---|
| Group Name | | Change in | Change in | body weight | |
| (No. of | Body weight | body weight | body weight | compared to | P value (body |
| broilers) | (kg) | (%) | (kg) | control (%) | weight gain) |
| Control (19) | 1934 ± 0.080 | 0.00 | 1.892 ± 0.081 | 0.00 | n/a |
| E1 (13) | 2.035 ± 0.065 | 5.18 | 1.991 ± 0.064 | 5.21 | 0.383036 |
| E2 (20) | 1.840 ± 0.055 | −4.90 | 1.798 ± 0.055 | −4.98 | 0.335987 |
| E3 (22) | 1.924 ± 0.066 | −0.51 | 1.864 ± 0.068 | −0.45 | 0.936196 |
| E4 (16) | 2.067 ± 0.065 | 6.84 | 2.026 ± 0.065 | 7.06 | 0.217913 |
| E5 (18) | 2.011 ± 0.052 | 3.95 | 1.968 ± 0.053 | 4.04 | 0.438582 |

TABLE 17
Average total body weight of the female broilers

| | | | | Change in body | |
|---|---|---|---|---|---|
| Group Name | | Change in | Change in | weight | P value |
| (No. of | Body weight | body weight | body weight | compared to | (body |
| broilers) | (kg) | (%) | (kg) | control (%) | weight gain) |
| Control (18) | 1.465 ± 0.077 | 0 | 1.422 ± 0.077 | 0 | n/a |
| E1 (20) | 1.456 ± 0.083 | −0.65 | 1.416 ± 0.083 | −0.43 | 0.958056 |
| E2 (17) | 1.476 ± 0.067 | 0.70 | 1.435 ± 0.067 | 0.96 | 0.895015 |
| E3 (13) | 1.608 ± 0.063 | 9.72 | 1.566 ± 0.063 | 10.14 | 0.18327 |
| E4 (21) | 1.714 ± 0.065 | 16.96 | 1.670 ± 0.065* | 17.51 | 0.017855 |
| E5 (19) | 1.682 ± 0.050 | 14.80 | 1.641 ± 0.050* | 15.43 | 0.021798 |

Table 18 below summarizes the variation on the body weight of the male and female broilers.

TABLE 18
Body weight variation among male and female
broilers

| | | Male: | | Female: |
|---|---|---|---|---|
| | | change in | Female | change in |
| Group | Male (CV %) | (%) | (CV %) | (%) |
| Control | 18.1 | 0 | 22.4 | 0 |
| E1 | 11.5 | −0.36 | 25.6 | 14.51 |
| E2 | 13.4 | −0.26 | 18.8 | −15.86 |
| E3 | 16.6 | −0.08 | 14.1 | −36.89 |
| E4 | 12.6 | −0.30 | 17.4 | −21.94 |
| E5 | 11.1 | −0.39 | 13.0 | −41.87 |

When the results in Tables 16 to 18 are considered together, there is illustrated that the effect of the cysteamine-containing diet in promoting increase in body weight is more significant in female broilers. For example, there is an increase of weight gain by 14.8% in Group E5 female broilers (Table 17) while in Group E5 male broilers, there was only an increase of 3.95% (Table 16). It is thus indicated that cysteamine is effective in preferentially promoting growth of female fowls over male fowls.

Table 19 below summarizes the feed conversion rate (FRR) of the groups of broilers

TABLE 19
FCR of the broilers

| Group | FCR | Change (%) | P value (FCR) |
|---|---|---|---|
| Control | 1.791 ± 0.012 | 0.00 | n/a |
| E1 | 1.759 ± 0.030 | −1.81 | 0.35617 |
| E2 | 1.777 ± 0.036 | −0.80 | 0.71735 |
| E3 | 1.716 ± 0.048 | −4.24 | 0.17772 |
| E4 | 1.698 ± 0.107 | −5.20 | 0.41851 |
| E5 | 1.780 ± 0.020 | −0.66 | 0.63453 |

As shown in Table 19, all the broilers in the test groups (e.g. Group 5) that administered with a cysteamine-containing diet had a substantially lower FCR meaning they were more effective in converting feed into body weight.

Table 20 below summarizes the weight of different parts of selected broilers of both sexes as a percentage of the total body weight after cleaning at the end of the experiment.

TABLE 20
Weight percentage of different parts of selected
broilers of both sexes

| | | | Whole | Thigh | | Breast |
|---|---|---|---|---|---|---|
| Group (no. | Slaughter | Half thorax | thorax | muscle | Leg muscle | muscle |
| of animals) | weight (%) | weight (%) | weight (%) | weight (%) | weight (%) | weight (%) |
| Control (8) | 90.91 ± 0.69 | 80.11 ± 3.10 | 69.32 ± 0.96 | 14.02 ± 0.35 | 8.58 ± 0.29 | 19.98 ± 0.23 |
| E1 (8) | 91.10 ± 0.47 | 83.62 ± 1.13 | 70.66 ± 1.15 | 13.49 ± 0.47 | 8.52 ± 0.28 | 21.74 ± 0.53** |
| E2 (8) | 91.51 ± 0.69 | 84.95 ± 0.60 | 71.79 ± 0.61* | 13.90 ± 0.33 | 8.67 ± 0.22 | 20.86 ± 0.50 |
| E3 (8) | 91.89 ± 0.59 | 85.17 ± 0.70 | 71.92 ± 0.75 | 13.71 ± 0.28 | 8.85 ± 0.26 | 21.38 ± 0.32** |
| E4 (8) | 90.65 ± 0.31 | 84.71 ± 0.31 | 72.17 ± 0.34* | 13.59 ± 0.33 | 8.49 ± 0.24 | 21.62 ± 0.27** |
| E5 (8) | 91.24 ± 0.29 | 85.15 ± 0.25 | 71.87 ± 0.33* | 13.32 ± 0.33 | 8.55 ± 0.13 | 20.69 ± 0.68 |

Table 21 below summarizes the weight percentage of different parts of the selected male broilers at the end of the experiment

TABLE 21
Weight percentage of different parts of selected
male broilers

| | | | Whole | Thigh | | Breast |
|---|---|---|---|---|---|---|
| Group (no. | Slaughter | Half thorax | thorax | muscle | Leg muscle | muscle |
| of animals) | weight (%) | weight (%) | weight (%) | weight (%) | weight (%) | weight (%) |
| Control (4) | 90.62 ± 1.40 | 75.85 ± 5.67 | 68.50 ± 1.73 | 14.27 ± 0.60 | 8.83 ± 0.42 | 19.89 ± 0.21 |
| E1 (4) | 90.67 ± 0.93 | 81.49 ± 1.68 | 68.42 ± 1.58 | 14.26 ± 0.50 | 8.92 ± 0.28 | 21.20 ± 0.70 |
| E2 (4) | 90.67 ± 0.19 | 84.28 ± 0.62 | 71.10 ± 0.49 | 14.18 ± 0.34 | 8.74 ± 0.04 | 20.29 ± 0.75 |
| E3 (4) | 92.57 ± 0.40 | 86.27 ± 0.55 | 73.49 ± 0.20* | 13.88 ± 0.45 | 9.21 ± 0.38 | 22.00 ± 0.38** |
| E4 (4) | 90.77 ± 0.28 | 84.31 ± 0.43 | 71.85 ± 0.55 | 13.93 ± 0.46 | 8.56 ± 0.41 | 21.43 ± 0.47* |
| E5 (4) | 91.19 ± 0.17 | 84.98 ± 0.31 | 71.51 ± 0.45 | 13.74 ± 0.59 | 8.47 ± 0.15 | 19.59 ± 0.46 |

Table 22 below summarizes the weight percentage of different parts of the selected female broilers at the end of the experiments

TABLE 22
Weight percentage of different parts of selected
female broilers

| | | | Whole | Thigh | | Breast |
|---|---|---|---|---|---|---|
| Group (no. | Slaughter | Half thorax | thorax | muscle | Leg muscle | muscle |
| of animals) | weight (%) | weight (%) | weight (%) | weight (%) | weight (%) | weight (%) |
| Control (4) | 91.20 ± 0.43 | 84.37 ± 0.84 | 70.15 ± 0.94 | 13.78 ± 0.43 | 8.34 ± 0.41 | 20.08 ± 0.45 |
| E1 (4) | 91.54 ± 0.20 | 85.76 ± 0.35 | 72.90 ± 0.54* | 12.72 ± 0.63 | 8.11 ± 0.44 | 22.28 ± 0.78 |
| E2 (4) | 92.35 ± 1.31 | 85.63 ± 1.01 | 72.47 ± 1.10 | 13.63 ± 0.58 | 8.61 ± 0.46 | 21.44 ± 0.60 |
| E3 (4) | 91.21 ± 1.07 | 84.07 ± 1.07 | 70.36 ± 0.97 | 13.54 ± 0.39 | 8.50 ± 0.28 | 20.75 ± 0.30 |
| E4 (4) | 90.56 ± 0.54 | 85.11 ± 0.39 | 72.49 ± 0.39 | 13.25 ± 0.46 | 8.42 ± 0.29 | 21.81 ± 0.32* |
| E5 (4) | 91.28 ± 0.60 | 85.31 ± 0.43 | 72.24 ± 0.48 | 12.91 ± 0.16 | 8.63 ± 0.22 | 21.79 ± 1.07 |

The major meat source from fowls includes mainly breast meat, leg meat and thigh meat. When the results in Tables 20 to 22 are considered together, there is shown that cysteamine was in particular effective in preferentially increasing the breast muscle weight as a percentage of the total body weight in all of the test broilers. For instance, in Table 20, the percent breast muscles of the Group 5 chickens had increased to 20.69 wt % when compared to the control groups while the percent leg muscles had remained generally unchanged. It is shown that the weight gain of the breast muscles as a percentage of the total body weight in all of Groups E1 to E5 of chickens was higher than any of the other muscle weight categories.

Referring to Tables 21 and 22, it is shown that the effect of the cysteamine-containing diet in preferentially promoting weight gain in breast muscles is more prominent in female broilers. This is partly supported by the data that in the two Group 5 male and female broilers, the breast muscle weight of the male broilers remained generally unchanged at about 19.59 wt % while that of the female broilers increased significantly to about 21.79 wt %.

### Experiment 4

Background Information

Similar to Experiment 3, this experiment sought to ascertain the effect(s) of a cysteamine-containing composition on growth in poultry such as chickens.

In this experiment, 350 broilers were initially obtained but only 300 of which were randomly selected for use in the experiment. The broilers were kept in farmhouses under similar condition in Experiment 3. The broilers were also immunized with vaccines as summarized in Table 11 above.

Materials

The nutritional value of a basal feed used to feed the broilers is summarized below in Table 23.

TABLE 23
Nutritional value of the basal feed

| | Age during | Age during | |
|---|---|---|---|
| Nutritional | day 0 | day 22 | Age during day 22 |
| composition* | to 21 | to 35 | to 42 |
| Crude protein (%) | 21.4 | 20.2 | 19.2 |
| Metabolic | 2950 | 3050 | 3100 |
| energy (Kcal/kg) | | | |
| Fat (%) | 3.65 | 5.10 | 6.13 |
| Sodium Chloride (%) | 0.35 | 0.35 | 0.35 |
| Calcium (%) | 0.92 | 0.90 | 0.85 |
| Phosphorous (%) | 0.45-0.47 | 0.42-0.45 | 0.38-0.43 |
| Lysine (%) | 1.20 | 1.08 | 1.00 |
| Methionine (%) | 0.47 | 0.45 | 0.38 |
| Methionine + | 0.90 | 0.88 | 0.82 |
| cystine (%) | | | |

*A trace amount of other essential minerals and vitamins in accordance with the nutritional requirements of AA broilers was added to the basal feed.

The same cysteamine-containing composition used in Experiment 3 was used in this experiment.

Procedure

The 300 broilers were randomly separated into three groups, with two groups of 100 broilers as test groups and one group of 100 broilers as control group. In each group, half of the broilers were male and the other half were female.

Table 24 below summarizes the concentration of the cysteamine-containing composition in the basal feed used during the experiment.

TABLE 24
Concentration of cysteamine-containing
composition in basal feed

| Group Name | Age: day 1 to 10 | Age: day 11 to 21 | Age: day 22 to 42 |
|---|---|---|---|
| Control | 0 | 0 | 0 |
| Test 1 | 0 | 400 | 400 |
| Test 2 | 0 | 0 | 400 |

The experiment was otherwise conducted similarly to Experiment 3.

Results and Discussions:

Tables 25 to 28 below summarize the average total body weight, the coefficient of variation of the body weight, the feed consumption and the fee conversion coefficient (FCR), of the broilers, respectively.

TABLE 25
Average total body weight of the broilers

| | Average | | | | |
|---|---|---|---|---|---|
| | total | Change | | Change in | P value |
| | body | in body | Change in | body weight | (body |
| Group | weight | weight | body weight | compared to | weight |
| Name | (kg) | (%) | (kg) | control (%) | gain) |
| Control | 2.23 ± 0.20 | 0.00 | 2.18 ± 0.20 | 0.00 | N/A |
| Test 1 | 2.30 ± 0.22 | 3.14 | 2.25 ± 0.22 | 3.21 | 0.0277* |
| Test 2 | 2.38 ± 0.23 | 6.73 | 2.34 ± 0.22 | 7.34 | 0.0000*** |

Note
*P < 0.05,
**P < 0.01,
***P < 0.001

As shown in Table 25, the cysteamine-containing diet had effect in promoting the average body weight of the broilers. In particular, as shown in Test Group 2, the effect of the cysteamine-containing diet was more prominent when administered at a later development stage.

TABLE 26
Body weight variation among male and female
broilers

| | | Male: | | Female: change |
|---|---|---|---|---|
| Group | Male (CV %) | change in % | Female (CV %) | in % |
| Control | 9.18 | 0 | 6.95 | 0 |
| Test 1 | 8.04 | −12.41 | 6.35 | −8.63 |
| Test 2 | 6.60 | −28.11 | 6.96 | 0.14 |

Note
CV % = SD/weight * 100

TABLE 27
Feed consumption of the broilers

| | | Change | |
|---|---|---|---|
| | Feed consumption | compared to | |
| Group | (kg per broiler) | control (%) | P value |
| Control | 4.29 ± 0.05 | 0.00 | N/A |
| Test 1 | 4.27 ± 0.09 | −0.47 | 0.5886 |
| Test 2 | 4.46 ± 0.22 | 3.96 | 0.0321* |
| Control (male only) | 4.33 ± 0.04 | 0.00 | N/A |
| Test 1 (male only) | 4.35 ± 0.03 | 0.58 | 0.2786 |
| Test 2 (male only) | 4.65 ± 0.16 | 7.42 | 0.0025** |
| Control (female only) | 4.25 ± 0.05 | 0.00 | N/A |
| Test 1 (female only) | 4.19 ± 0.06 | −1.50 | 0.0918 |
| Test 2 (female only) | 4.28 ± 0.07 | 0.71 | 0.5473 |

As shown in Table 27, when the data for the two test groups of broilers are considered together, the cysteamine-containing diet generally promoted higher consumption of the feed.

TABLE 28
FCR of the broilers

| Group | FCR | Change in % | P value |
|---|---|---|---|
| Control | 1.97 ± 0.08 | 0.00 | N/A |
| Test 1 | 1.90 ± 0.09 | −3.36 | 0.1152 |
| Test 2 | 1.92 ± 0.07 | −2.54 | 0.1615 |
| Control (male only) | 1.91 ± 0.07 | 0.00 | N/A |
| Test 1 (male only) | 1.82 ± 0.05 | −4.77 | 0.0424* |
| Test 2 (male only) | 1.87 ± 0.07 | −1.85 | 0.4413 |
| Control (female only) | 2.03 ± 0.04 | 0.00 | N/A |
| Test 1 (female only) | 1.98 ± 0.03 | −2.03 | 0.1281 |
| Test 2 (female only) | 1.96 ± 0.04 | −3.18 | 0.0406* |

As shown above, there was a general decrease in the FCR for test broilers administered with the cysteamine-containing diet. This means that the test broilers were more efficient in converting the feed into body weight gain.

Table 29 below summarizes the weight percentage of different parts of selected broilers.

TABLE 29
Weight percentage of body parts

| | | | | | Leg | |
|---|---|---|---|---|---|---|
| | | | Whole | Thigh | muscle | Breast |
| | Slaughter | Half thorax | thorax | muscle | weight | muscle |
| Group | weight (%) | weight (%) | weight (%) | weight (%) | (%) | weight (%) |
| Control | 91.70 ± 0.79 | 93.82 ± 0.91 | 79.15 ± 1.39 | 10.85 ± 1.01 | 6.94 ± 0.80 | 16.39 ± 1.56 |
| (20 male | | | | | | |
| and | | | | | | |
| female) | | | | | | |
| Test 1 | 91.91 ± 0.76 | 94.31 ± 0.64 | 79.61 ± 1.02 | 10.86 ± 0.88 | 6.90 ± 0.65 | 16.22 ± 1.28 |
| (20) | | | | | | |
| Test 2 | 91.86 ± 0.62 | 94.61 ± 0.66** | 80.70 ± 1.80** | 10.60 ± 0.98 | 6.68 ± 0.85 | 17.66 ± 1.31** |
| (20) | | | | | | |
| Control | 91.56 ± 0.84 | 93.65 ± 1.16 | 79.20 ± 1.49 | 10.42 ± 0.95 | 6.77 ± 0.94 | 16.82 ± 1.86 |
| (10 | | | | | | |
| male) | | | | | | |
| Test 1 | 92.04 ± 0.68 | 94.13 ± 0.41 | 79.89 ± 1.03 | 10.48 ± 0.61 | 6.71 ± 0.49 | 16.66 ± 1.26 |
| (10) | | | | | | |
| Test 2 | 91.88 ± 0.71 | 94.67 ± 0.63* | 81.54 ± 2.03** | 10.14 ± 0.62 | 6.55 ± 1.00 | 18.19 ± 1.28 |
| (20) | | | | | | |
| Control | 91.84 ± 0.77 | 93.99 ± 0.58 | 79.10 ± 1.37 | 11.29 ± 0.90 | 7.10 ± 0.66 | 15.96 ± 1.11 |
| (10 | | | | | | |
| female) | | | | | | |
| Test 1 | 91.78 ± 0.84 | 94.48 ± 0.79 | 79.33 ± 0.99 | 11.24 ± 0.96 | 7.09 ± 0.76 | 15.77 ± 1.20 |
| (10) | | | | | | |
| Test 2 | 91.84 ± 0.56 | 94.55 ± 0.72 | 79.85 ± 1.05 | 11.07 ± 1.08 | 6.81 ± 0.69 | 17.12 ± 1.15* |
| (10) | | | | | | |

As shown in Tables 24 and 29, when administered at the appropriate development stage, the cysteamine-containing diet was more effective in increasing the weight percent of breast muscles than the other muscle types.

The above results in Experiments 3 and 4 are also significant in a number of ways. In the past, when a pool of male and female chickens is raised together in a farm, male chickens normally mature and grow to a preferred size and weight faster than the female chickens, and for this reason more male chickens are accordingly removed from the farm. It can be envisaged that as more and more of the male chickens are harvested, there will be more remaining female chickens left in the chicken pool. This is undesirable not just from an administrative point of view, but also that female chickens normally have lower feed conversion rate and the remaining pool of chickens will become less efficient in their productivity as more male chickens are harvested. However, when administered with a cysteamine-containing diet, the female chickens in the pool will become more productive in relation to their male counterpart such that both management of the pool of chickens will become easier and the overall feed conversion rate can at least be maintained if not increased.

It is envisaged that the present invention can be applied to other fowls.

The contents of each of the references discussed above, including the references cited therein are herein incorporated by reference in their entirety. It is to be noted that numerous variations, modifications, and further embodiments are possible and accordingly, all such variations, modifications and embodiments are to be regarded as being within the scope of the present invention.

1. The use of cysteamine or a cysteamine-containing composition for increasing the yield and/or quality of eggs produced by fowls.

2. The use of cysteamine or a cysteamine-containing composition for preferentially promoting growth of female fowls over male fowls.

3. The use of cysteamine or a cysteamine-containing composition for preferentially promoting development of breast muscles of fowls over development of muscles other than said breast muscles.

4. The use according to claim 1, 2 or 3 wherein said composition comprises substantially 1 to 95 wt % cysteamine having the chemical formula of NH₂—CH₂—CH₂—SH or its salt like compounds.

5. The use according to claim 4 wherein said composition comprises substantially 30 wt % cysteamine.

6. The use according to claim 1, 2 or 3 wherein said composition comprises 1 to 80 wt % of a stabilizer.

7. The use according to claim 6 wherein said stabilizer is selected from a group including cyclodextrin and/or its derivatives.

8. The use according to claim 6 wherein said composition comprises substantially 10 wt % of said stabilizer.

9. The use according to claim 1, 2 or 3 wherein said composition further comprises ingredient (s) selected from a group including a bulking agent, a disintegration agent and a coated carrier.

10. The use according to claim 9 wherein said carrier it's a solid carrier.

11. The use according to claim 9 wherein said carrier is a coating soluble in intestines of said fowls.

12. The use according to claim 9 wherein said carrier exhibits a multi-layer structure in said composition.

13. The use according to claim 9 wherein said carrier is adapted to remain un-dissolved at pH 1.5 to 3.5.

14. The use according to claim 1, 2 or 3 for the manufacture of a feed for said fowls.

15. The use according to claim 14 wherein said feed comprises substantially 50 to 3000 ppm of said composition.

16. The use according to claim 14 wherein said feed comprises substantially 15 to 900 ppm of cysteamine.

17. The use according to claim 16 wherein said feed comprises substantially 120 ppm of cysteamine.

18. The use according to claim 14 wherein said feed comprises other foodstuffs selected from a group including maize, soybean, yeast, fish meal, bone meal, shell meal, salts, amino acids preferably methionine, and vitamins.

19. A method of raising fowls comprising:
(a) mixing cysteamine or a cysteamine-containing composition with a suitable feed material for said fowls, and
(b) feeding said fowls with said feed material.

20. A method according to claim 19 wherein said mixing in step (a) comprises directly mixing said composition with said feed material.

21. A method according to claim 19 wherein said mixing in step (a) comprises firstly preparing a pre-mix including cysteamine or said cysteamine-containing composition, and subsequently mixing said pre-mix with said feed material.

22. A feed for increasing the yield and/or quality of eggs produced by fowls comprising cysteamine or a cysteamine-containing composition.

23. A feed for preferetially promoting growth of female fowls over male fowls comprising a cysteamine-containing compositions.

24. A feed for preferentially promoting development of breast muscles of fowls over development of muscles other than said breast muscles comprising a cysteamine-containing composition.

25. A feed according to claim 22, 23 or 24 comprising substantially 1 to 95 wt % cysteamine having the chemical formula of NH₂—CH₂—CH₂—SH or its salt like compounds.

26. A feed according claim 25 wherein said composition comprises substantially 30 wt % cysteamine.

27. A feed according to claim 22, 23 or 24 comprising substantially 15 to 900 ppm cysteamine.

28. A feed according to claim 27 comprising substantially 120 ppm cysteamine.

29. A feed according to claim 22, 23 or 24 comprising substantially 50 to 3000 ppm of said cysteamine-containing composition.

30. A feed according to claim 22, 23 or 24 wherein said composition further comprises 1 to 80 wt % of a stabilizer.

31. A feed according to claim 30 wherein said stabilizer is selected from a group including cyclodextrin and/or its derivatives.

32. A feed according to claim 30 wherein said composition comprises 10 wt % of said stabilizer.

33. A feed according to claim 22, 23 or 24 wherein said composition further comprises ingredient(s) selected from a group including a bulking agent, a disintegration agent and a coated carrier.

34. A feed according to claim 33 wherein said carrier is a solid carrier.

35. A feed according to claim 34 wherein said carrier is a coating soluble in intestines of said fowls.

36. A feed according to claim 33 wherein said carrier exhibits a multi-layer structure in said composition.

37. A feed according to 34 wherein said carrier is adapted to remain un-dissolved at pH 1.5 to 3.5.

38. A feed according to claim 22, 23 or 24 comprising other foodstuffs selected from a group including maize, soybean, yeast, fish meal, bone meal, shell meal, salts, amino acids such as methionine, and vitamins.

39. A method of preparing a feed as claimed claim 22, 23 or 24 comprising a step of mixing said cysteamine or said cysteamine-containing composition with a suitable basal feed material.
